(19) United States
(12) Patent Application Publication
(10) Pub. No.: US 2026/0341009 A1
(43) Pub. Date: Oct. 29, 2026

(54) AN ULTRA-CONFIDENTIAL SELF-TRAINING AND VIDEO ANALYTICS SYSTEM FOR UNCOMMON OBJECTS

(71) Applicant: VisionMatrix Technology Limited, Hong Kong (HK)

(72) Inventors: Xin LIANG, Hong Kong (HK); Kai Ki LEE, Hong Kong (HK); Peijie HUANG, Hong Kong (HK); Runqiu YAO, Hong Kong (HK)

(21) Appl. No.: 19/727,034

(22) Filed: Jul. 1, 2026

Related U.S. Application Data
(63) Continuation of application No. 18/795,326, filed on Aug. 6, 2024.

(51) Int. Cl. G06V 10/82; G06V 10/774; G06V 20/70

(52) U.S. Cl. CPC G06V 10/82; G06V 10/774; G06V 20/70

(57) ABSTRACT

Acustomized self-training machine learning system for video analytics for rare targets. The customized self-training machine learning system has a data processing module, a data annotation module with a labeling module, an automatic model training module configured to self-train the model based on the user’s desire to detect rare targets, a model verification module with automatic error analysis and label approval to optimize the model, a model deployment module coupled with a user operation interface module, and a video analysis module based on the trained rare targets.

### CROSS-REFERENCE TO RELATED APPLICATIONS

The present application is a continuation of U.S. Application No.: 18/795,326, filed on Aug. 6, 2024, presently pending.

### BACKGROUND OF THE INVENTION

The present invention relates to a machine learning technology. More particularly, the present invention pertains to an ultra-confidential self-training and video analytics system for uncommon objects.

Along with the rapid development of new technologies such as 5G, Big Data, Cloud Computing, IoT (Internet of Things), and AI (Artificial Intelligence), the means of record for human civilization are shifting from texts and pictures to videos, which has led to an accumulation as well as an explosion of videos. Despite the wealth of information provided by videos, managing the vast volume of videos data poses significant challenges in terms of time and financial resources. According to data from the China Internet Network Information Center (CNNIC), as of December 2021, China had a staggering 975 million online video users, representing 90.5% of total internet users, underscoring the pivotal role of video streaming in the information age. Video streaming has emerged as the cornerstone of modern information infrastructure, playing a crucial role in both transmission and reception of information, and closely intertwined with human civilization. However, the sheer volume of videos being generated, disseminated, and accumulated presents hurdles in effectively searching for videos information and complicates video monitoring efforts.

Therefore, the utilization of deep learning aids in analyzing the vast quantities of videos. However, to date, there are a lack of effective and comprehensive methods and systems for video analytics using deep learning machine even there are a few existing methods and systems in the market that assist in video analytics systems. Some of these examples are discussed in the following prior arts.

China Patent Publication No. 114707667A discloses a data-driven automatic model training and application system, which expands the labeled data quantity by carrying out data transformation in various ways on heterogeneous labeled data such as text and image data; designing a reasonable calculation network and a super parameter for the enhanced labeled data set based on a neural network architecture search technology; and finally, carrying out model distillation according to the software and hardware conditions and the data characteristics of the deployment end, and issuing to the service end for deployment. The system solves the practical problems that model training data in the deep learning field are difficult to prepare, parameters are difficult to adjust and the requirement of a trained model on hardware resources is high, and the like, and realizes the capability of automatic model training and model publishing service application through a small amount of standard labeled data. However, the prior art is merely providing automatic model training and lacks the capability or functionality to perform video analytics. Besides, the invention requires the users to engage in any of the built-in algorithm, code, or development layer operations. At times, the users who lack sufficient knowledge of the machine learning model may encounter difficulties when trying to interact with the system.

United States Patent Publication No. 20160132787A1 discloses a system that provides multi-methodology, multi-user, self-optimizing Machine Learning as a Service which automates and optimizes the model training process. The system uses a large-scale distributed architecture and is compatible with cloud services. The system uses a hybrid optimization technique to select between multiple machine learning approaches for a given dataset. The system can also use datasets to transfer knowledge of how one modeling methodology has previously worked over to a new problem. However, the invention requires the users to engage in any of the built-in algorithm, code, or development layer operations. At times, the users who lack sufficient knowledge of the machine learning model may encounter difficulties when trying to interact with the system. Besides, the prior art necessitates the manual deployment either on a single computer or across multiple computers within a single site, or even distributed across multiple sites interconnected by a communication network, thereby requiring additional workforce, and incurring higher cost.

United States Patent Publication No. 20190102700A1 discloses an integrated machine learning platform. The machine learning platform can convert machine learning models with different schemas into machine learning models that share a common schema, organize the machine learning models into model groups based on certain criteria, and perform pre-deployment evaluation of the machine learning models. The machine learning models in a model group can be evaluated or used individually or as a group. The machine learning platform can be used to deploy a model group and a selector in a production environment, and the selector may learn to dynamically select the model(s) from the model group in the production environment in different contexts or for different input data, based on a score determined using certain scoring metrics, such as certain business goals. However, the users need to manually intervene in the cleaning and verification processes, where the users may create a data flow to train a model and execute the data flow to create the model. Although automation is present in the prior art, the emphasis is on user-created data flows. The level of automation in data preparation steps depends on how much the user includes in the data flow and the extent of user involvement in data preparation steps is determined by what the user includes in the data flow. This implies that the users must possess deep expertise in both creating and managing data to effectively execute the model. Besides, the platform can be implemented under various environments including a cloud environment, on-premises environment, a hybrid environment, and the like. Users may lack control over their resources and cannot guarantee the privacy and security of their confidential data. Therefore, this may not be suitable for managing private and confidential data, as it could potentially expose sensitive information to the public.

United States Patent No. 10380498B1 discloses automated generation of Machine Learning (ML) models. The system receives a user directive containing one or more requirements for building the ML model. The system further identifies common requirements between the user directive and one or more prior user directives and associates characteristics of the prior user directive, or model generated therefrom, with the user directive. The system further associates performance values generated by continuous monitoring of deployed ML models to individual characteristics of the user directive used to generate each of the deployed ML models. The system continuously improves model generation efficiency, model performance, and first run performance of individual ML models by learning from the improvements made to one or more prior ML models having similar characteristics. However, the prior art centered on a system that receives user directives, encompassing raw data sources and modeling options, for executing machine learning tasks through a series of modeling steps. This means that it requires a direct user involvement in detailed modeling steps, which relies on user-provided directives, showcasing greater user control and input in the machine learning process. Furthermore, the prior art suggests the distribution of model resources to be in a cloud-computing environment. Users may lack control over their resources and cannot guarantee the privacy and security of their confidential data. Therefore, this may not be suitable for managing private and confidential data, as it could potentially expose sensitive information to the public.

United States Patent No. 11694122B2 discloses a distributed, online machine learning system. Contemplated systems include many private data servers, each having local private data. Researchers can request that relevant private data servers train implementations of machine learning algorithms on their local private data without requiring de-identification of the private data or without exposing the private data to unauthorized computing systems. The private data servers also generate synthetic or proxy data according to the data distributions of the actual data. The servers then use the proxy data to train proxy models. When the proxy models are sufficiently similar to the trained actual models, the proxy data, proxy model parameters, or other learned knowledge can be transmitted to one or more non-private computing devices. The learned knowledge from many private data servers can then be aggregated into one or more trained global models without exposing private data. However, the prior art merely concentrates on training machine learning and generating a system using limited healthcare data, including patient-specific information and creates the trained actual model. Thus, it requires a skilled person to manage the machine learning system. Besides, the prior art lacks the capability or functionality to perform video analytics.

United States Patent Publication No. 20200012962A1 discloses a technology for automating deployment of a machine learning model. An example method may include receiving, via a graphical user interface, credentials for connecting to a data store containing a plurality of datasets and connecting to the data store using the credentials. A selection of a target metric to predict using the machine learning model can be received, via the graphical user interface, and datasets included in the plurality of datasets that correlate to the target metric can be identified by analyzing the datasets to identify an association between the target metric and data contained within the datasets. The datasets can be input to the machine learning model to train the machine learning model to generate predictions of the target metric, and the machine learning model can be deployed to computing resources in a service provider environment to generate predictions associated with the target metric. However, the graphical user interface in the prior art facilitates the deployment of the machine learning model to a service provider environment, including a public cloud environment, a private network and colocation network environment. The use of cloud environment may not be appropriate for handling private and confidential data, as it has the potential to inadvertently disclose sensitive information to the public. Besides, the prior art lacks the capability or functionality to perform video analytics.

China Patent Publication No. 106779087B discloses a kind of general-purpose machinery learning data analysis platform, including interface module, data memory module, preprocessing module, characteristic extracting module, feature conversion module, algoritic module and selection optimization module. The characteristic extracting module extracts the characteristic parameter from the data to be analyzed according to characteristic parameter set by user. The Feature Conversion module is used for feature conversion set by user into representation needed for user. The algoritic module includes many algorithms model selected for user and constructs model for user, and user constructs at least one set of models. The selection optimization module selects optimal model and optimal parameter from the model built, then saves the optimal model. The data that above-mentioned each module generates are stored in the data memory module. Users of the invention can freely combine modules and algorithm model, and can also establish composite model, and iteratively develops novel analysis model faster which greatly improves working efficiency. However, the modules and functions in the prior art are designed for experienced and knowledgeable users, such as data analysts. They can freely combine various modules and algorithm models to construct highly customized data analysis models without the need for coding skills. Hence, it may not be suitable for a user who is lacking knowledge of artificial intelligence. Further, the process data in the prior art is stored using a distributed storage platform or distributed database, allowing for easy expansion of the underlying system. Users lack control over their resources and cannot guarantee the privacy and security of their confidential data. Thus, it may not be suitable for private and confidential data as it has the potential to inadvertently disclose sensitive information to the public. In addition, the prior art lacks the capability or functionality to perform video analytics.

United States Patent No. 10366263B2 relates to systems, methods, devices, and other techniques for video camera self-calibration based on video information received from the video camera. In some implementations, a computing device receives video information characterizing a video showing a scene from a field of view of a video camera; detects an object that appears in the scene of the video; identifies a visual marking that appears on the detected object; determines a particular visual marking among a plurality of pre-defined visual markings that matches the visual marking that appears on the detected object; identifies one or more object characteristics associated with the particular visual marking; evaluates one or more features of the video with respect to the one or more object characteristics; and based on a result of evaluating the one or more features of the video with respect to the one or more object characteristics, sets a parameter of the video camera. However, the prior art focused on method of self-calibration for the video camera during recording. While the invention employs a deep learning object recognition classifier, such as a neural network trained for image recognition, it is however lacking the ability to train on new data or update its model over time autonomously, as well as the capability to self-learning. Thus, the system may not be adaptable to new data or evolving circumstances. This could limit its effectiveness in handling new or changing environments. The lack of self-learning capabilities may also further lead the invention to be unable to improve or adapt based on its own experiences or feedback, potentially leading to stagnation in performance and inability to adapt to new situations.

Malaysia Patent Publication No. PI 2012005288 discloses a video analytic system having a machine-learning engine for enabling the video analytic system to classify at least one object within an image of a video input in an unsupervised manner. The machine learning engine comprises a properties extraction unit configured to extract the object properties of object when the object is found novel to the system and a pixel cluster optimizer configured to generate a plurality of optimized parameter configurations that accurately describes the properties of the novel object by clustering the objects based on similarity of the object properties, segmenting pixels within each resultant cluster into several sub-clusters of substantially correlated pixels and subsequently combining the property value associated with each of the sub-clusters. However, the prior art is designed to learn features representing each object within a video frame over time, based on the learned features and parameters. This may indicate a high dependency on limited data. The system may also struggle to adapt to changes in the video content or environment over time. The learned features and parameters may become outdated, affecting the system’s ability to accurately recognize and classify objects. Further, the ongoing requirement for data updates could result in added expenses and time consumption. Besides, the lack of self-learning capabilities may also further lead the invention to be unable to improve or adapt based on its own experiences or feedback, potentially leading to stagnation in performance and inability to adapt to new situations.

Despite its disruptive significance to enterprise innovation and development, deep learning machine encounters challenges related to data availability, algorithm complexity, and computing power during implementation. Although deep learning offers the advantage of automatically extracting and learning features from thousands of labelled samples, resulting in high efficiency and accuracy, but, in real world scenarios involving non-universal, rare, or confidential data, existing products struggle to achieve the same level of accuracy. Certain applications, such as medical diagnostics, military operations, or rare species detection, often lack sufficient data due to their specialized nature. Moreover, concerns about data security sometimes prevent customers from providing developers with the necessary data for deep learning models, further complicating implementation. Besides, many enterprises face significant barriers in exploring and adopting deep learning technologies. This reluctance is often due to a lack of expertise in deep leaning and concerns about data privacy and security.

Therefore, there still remains a need in the field to provide a solution that solves the problems described herein.

### SUMMARY OF THE INVENTION

It is an objective of the present invention to provide a comprehensive system and method that encompass training, deployment, and video analysis.

It is also an objective of the present invention to provide an automated self-training system and method that is more accessible, user-friendly, low threshold and suitable for individual without basic knowledge.

It is further an objective of the present invention to provide system and method for video analysis that are tailored for users requiring rare, private, or customized target detection using a small amount of data.

It is also an objective of the present invention to provide a system and method with a guaranteed privacy and security of the confidential data.

Accordingly, these objectives may be achieved by following the teachings of the present invention. The present invention relates to a customized self-training machine learning system for video analytics for rare targets, comprising: a data processing module; a data annotation module with a labelling module; an automatic model training module configured to self-train the model based on the user’s desire to detect rare targets; a model verification module; wherein the model verification module comprises an automatic error analysis and a label approval to optimize the model; a model deployment module coupled with a user operation interface module; and a video analysis module based on the trained rare targets.

### BRIEF DESCRIPTION OF DRAWINGS

The features of the invention will be more readily understood and appreciated from the following detailed description when read in conjunction with the accompanying drawings of the preferred embodiment of the present invention, in which:

FIG. 1 illustrates the general diagram of the two main technical functions of the present invention;

FIG. 2 illustrates the schematic diagram depicting the divisions of the modules of the customized self-training machine learning system in the present invention;

FIG. 3 illustrates the schematic diagram depicting the divisions of the modules of the video analytic system in the present invention;

FIG. 4 illustrates the flowchart of the process of a customized self-training machine learning for video analytics system for uncommon objects;

FIG. 5 illustrates the cyclical and iterative process of the self-training machine learning in the present invention; and

FIG. 6 illustrates the sequence of steps involved in the user’s operations when operating the system in the present invention.

### DETAILED DESCRIPTION OF THE INVENTION

For the purposes of promoting and understanding of the principles of the invention, reference will now be made to the embodiments illustrated in the drawings and described in the following written specification. It is understood that the present invention includes any alterations and modifications to the illustrated embodiments and includes further applications of the principles of the invention as would normally occur to one skilled in the art to which the invention pertains.

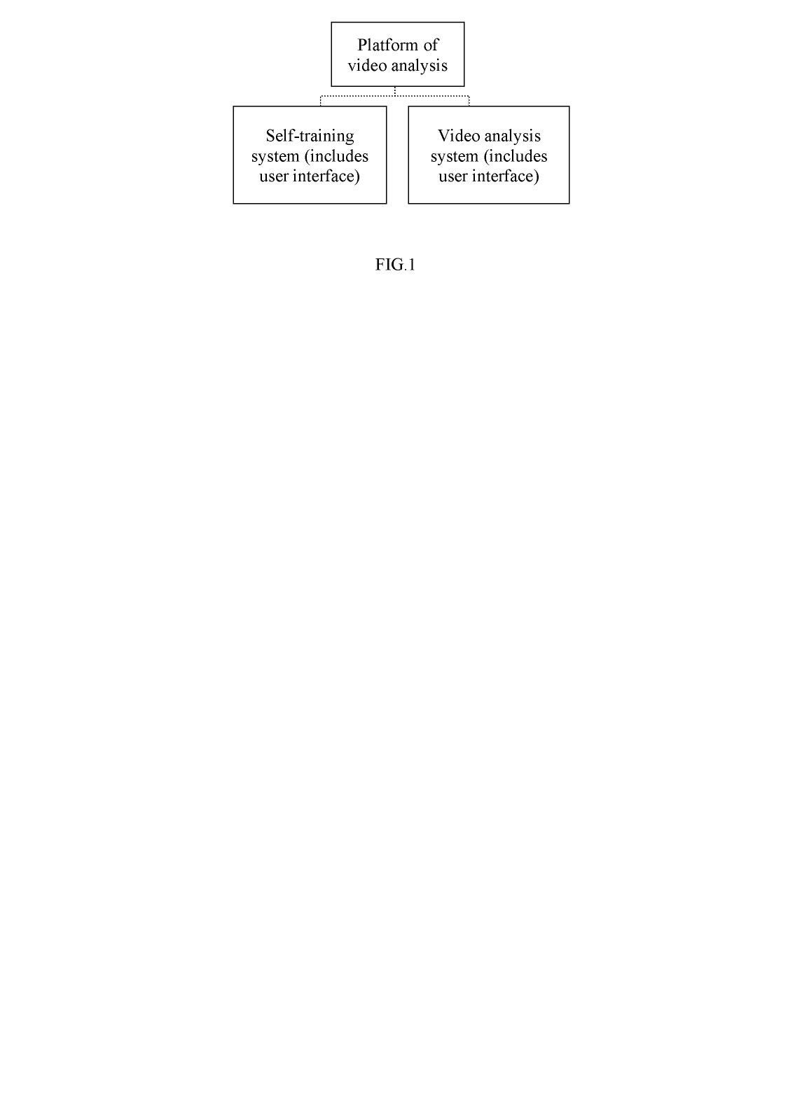

Referring to the drawings as shown in FIG. 1 to 6, the present invention will now be described in more detail.

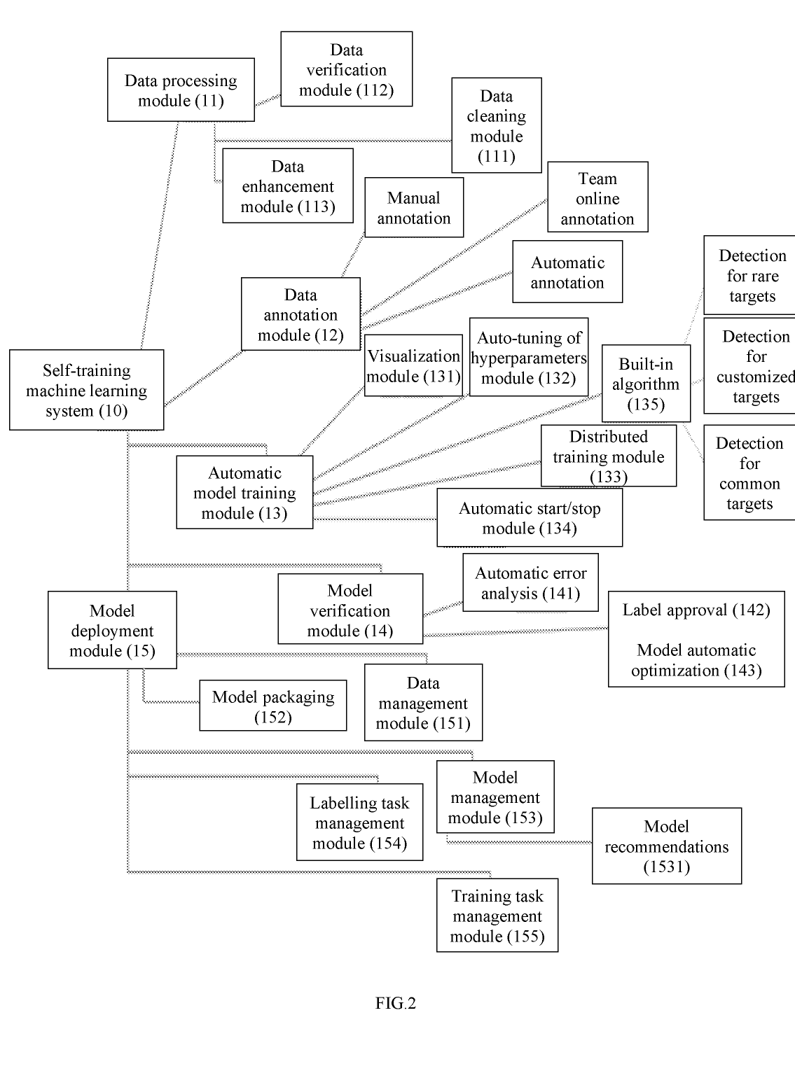

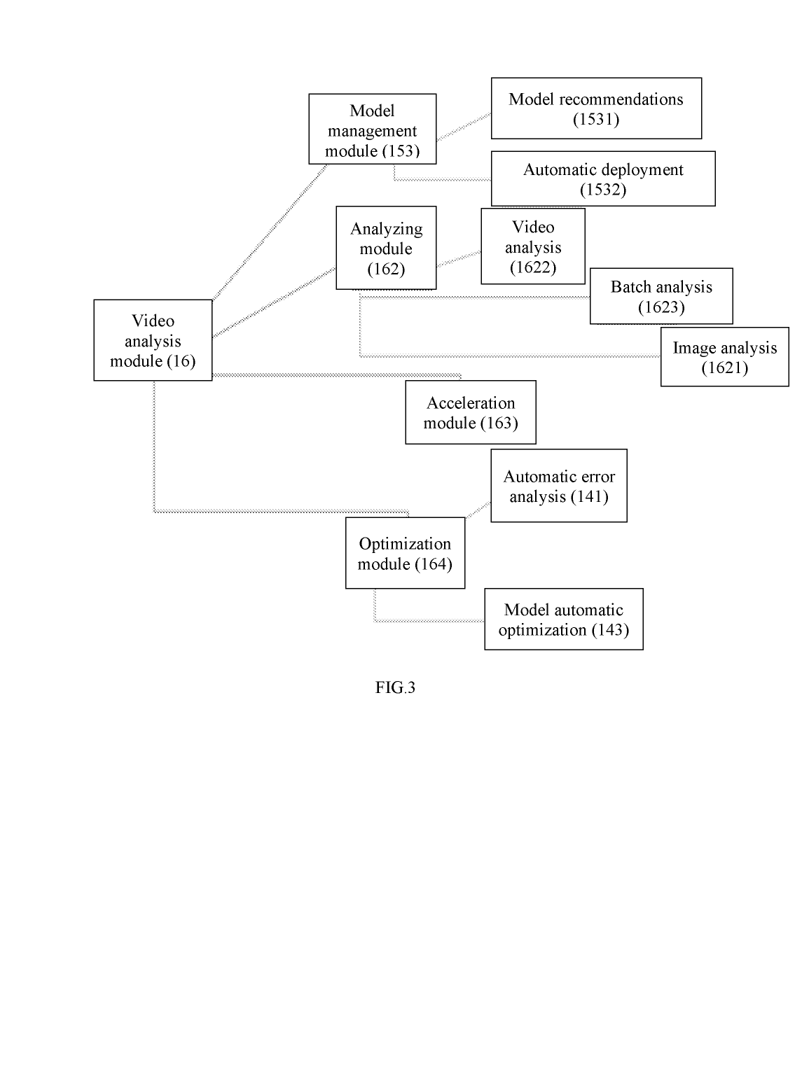

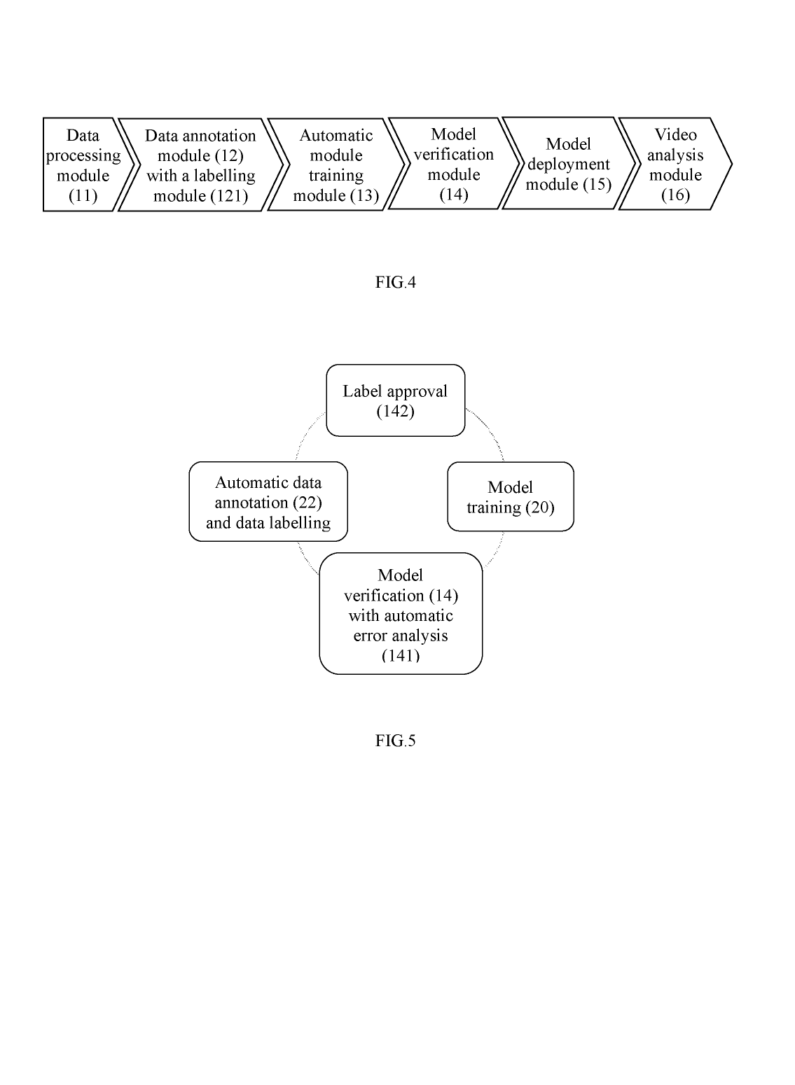

The present invention teaches a customized self-training machine learning system 10 for video analytics for rare targets. FIG. 1 shows that the system 10 has two main technical functions, and the FIG. 2 shows the schematic diagram depicting the divisions of the modules of the self-training machine learning system 10 in the present invention. FIG. 3 illustrates the schematic diagram depicting the divisions of the modules of the video analytic system in the present invention. The system 10 comprising: a data processing module 11; a data annotation module 12 with a labelling module 121; an automatic model training module 13 configured to self-train a machine learning model based on the user’s desire to detect rare targets; a model verification module 14; wherein the model verification module 14 comprises an automatic error analysis 141 and a label approval 142 to optimize the machine learning model; a model deployment module 15 coupled with a user operation interface module; and a video analysis module 16 based on the trained rare targets. Additionally, FIG. 4 shows the flowchart of the overall process of a customized self-training machine learning for video analytics system for uncommon objects. The uncommon objects are referred to as the rare targets in the present invention.

In accordance with a preferred embodiment of the present invention, the data processing module 11 comprises an automatic data cleaning module 111, a data verification module 112, and a data enhancement module 113. The data processing module 11 also involves automatic data inspection, and automatic data expansion.

In accordance with a preferred embodiment of the present invention, the automatic model training module 13 comprises a unimodal, a cross-modal, and a multimodal. The modal is trained to do inference tasks. This system 10 includes unimodal, which involves a single sensory modality such as visual, auditory, or textual inputs; crossmodal, which explores how one sensory modality influences the perception of another; and multimodal, which integrates inputs from multiple sensory modalities.

In accordance with a preferred embodiment of the present invention, the automatic model training module 13 comprises at least one built-in algorithm 135. The automatic model training module 13 has a variety of built-in algorithms 135, coding, or development layer operations to meet the different needs of users for the model. Users may have different preferences or specific needs regarding the amount of uploaded data, model accuracy, analysis speed, and memory consumption during model analysis. The automatic model training module 13 provides multiple training modes for the users to choose from, such as fast training mode, precise mode, and rare data mode. Each mode has different data volume requirements, with the training module 13 able to prioritize model training on rare data to achieve optimal accuracy.

In accordance with a preferred embodiment of the present invention, the automatic model training module 13 comprises meta-learning for detecting rare targets. The system 10 leverages meta-learning techniques, enabling it to learn effectively from small datasets. The meta-learning model also acts as an agent to perform specific tasks in agent routing architecture for fine-grain rare target tasks.

Additionally, meta-learning is utilized in the present invention to overcome common issues, such as inaccurate region proposals in existing object detection frameworks. This approach allows the system 10 to operate solely at the image level, without relying on region proposals.

In accordance with a preferred embodiment of the present invention, the automatic model training module 13 comprises a visualization module 131, an auto-tuning of hyperparameters module 132, a distributed training module 133 and an automatic start or stop module 134. The system 10 provides the visualization of the training process, which includes information such as displaying the current training progress, remaining time, and current training accuracy. Meanwhile, the auto-tuning of hyperparameters helps the users in selecting the best set of hyperparameters. As such, the users do not need to rely on or involve any algorithms, codes, and development layer operations to optimize the use process and experience. Users may rationally use the maximum resources according to real-time tasks to optimize the use process and experience through the distributed training module.

In accordance with a preferred embodiment of the present invention, the rare targets comprise scarce, non-general and confidential objects such as medical or military imaging. Designing and constructing a dependable model for the said rare, non-generic, or classified objects, such as those encountered in medical or military imaging, presents significant challenges when there is limited training data available. Thus, the invention incorporates meta-learning for the detection of rare targets.

In accordance with a preferred embodiment of the present invention, the automatic model training module 13 is configured to detect common targets and customized targets. For some common scenarios or targets, the present invention provides preset scenarios and their mature models as video analysis models. If the user’s needs are not met, the automatic model training method of custom target detection can be adopted. For some customized targets with a large amount of training data, the present invention uses transfer learning and freeze some network layers to accelerate and achieve high accuracy.

Further, once the initial model training is completed, the system 10 autonomously initiates and executes another model training 20 process in the background. This subsequent training 20 commences with model verification 14 which mainly involves automatic error analysis 141 and model automatic optimization 143, automatic data annotation 22 coupled with data labelling, and label approval 142. This process is depicted in FIG. 5 that illustrates the cyclical and iterative process of the self-training machine learning in the present invention.

In accordance with a preferred embodiment of the present invention, the model deployment module 15 comprises a data management module 151, a model packaging 152, a model management module 153, a labelling task management module 154, and a training task management module 155.

The data management module 151 in the present invention is coupled with an operation interface module. The user-friendly interface module is designed with the principle of empowering non-professionals with the capabilities of deep learning. As the system 10 in the present invention targets ordinary enterprises, the interface is exceedingly easy to use. The users are able to effortlessly perform management functions such as uploading, annotating, and managing their data with simple clicks, as well as access features for training, managing, deploying models, and performing video analysis.

In accordance with a preferred embodiment of the present invention, the model management module 153 is configured to provide model recommendations 1531 for users viewing specific information based on the generated model information. The users are able to perform operations such as model deletion and batch processing according to their needs using the operation interface. Users can see specific information such as the performance and creation time of all models on this management interface. The model management module 153 also provides the automatic deployment 1532 feature for the system 10.

Further, the labelling task management module 154 provides the labeling task management function with an operation interface. The users can perform operations such as deletion and batch processing of labeling tasks according to their needs. Users can also see specific information such as the modifier, modification time, and number of annotations of the annotation task on this management interface.

Besides, the present invention provides the training task management module 155 with an operation interface where users can open, delete, and other operations on training tasks according to their needs. Users may also see specific information such as training task status and performance on this management interface.

In accordance with a preferred embodiment of the present invention, the video analysis module 16 comprises a model management module 153, an analyzing module 162, an acceleration module 163, and a model optimization module 164. The model management module 153 is configured to provide model recommendations 1531 and automatic deployment 1532. The analyzing module 162 in the present invention is configured to provide an online and offline service of image analysis 1621, video analysis 1622, and batch analysis 1623. As such, the users can upload multiple pictures and videos to be analyzed. As the users do not need to involve any algorithms, codes, and development layer operations, they may rationally use the maximum resources according to real-time tasks to optimize the use process and experience, especially for batch analysis tasks in the acceleration module 163.

The acceleration module 163 assists the system 10 to match the corresponding computing power resources to achieve an analysis speed-up when the user inputs a large number of videos.

In accordance with a preferred embodiment of the present invention, the optimization module 164 is configured to execute automatic error analysis 141 and model automatic optimization 143 of the model to optimize the video analysis performance. After the analysis task is completed, the optimization function can be activated to realize automatic error analysis 141 and model automatic optimization 143 of the model to optimize video analysis performance. If the users want to improve the analysis quality of the current model, they can choose optimization.

In accordance with a preferred embodiment of the present invention, the system 10 further comprises network-attached storage (NAS) or storage area network (SAN) providing secure and large-capacity data storage. For users who store sensitive information in cloud-based systems, there are often concerns about data access. Therefore, the SAN or NAS in the present invention could provide a higher level of privacy and security without the possibility of prying eyes. In addition, competition for resources such as network congestion is resolved. The present invention includes robust computing processors for demanding workloads, scalable memory, high stability, and rapid transfer rates. As a result, due to the ultra-secrecy system in the present invention, system developers or any unrelated personnel will not have access to training data.

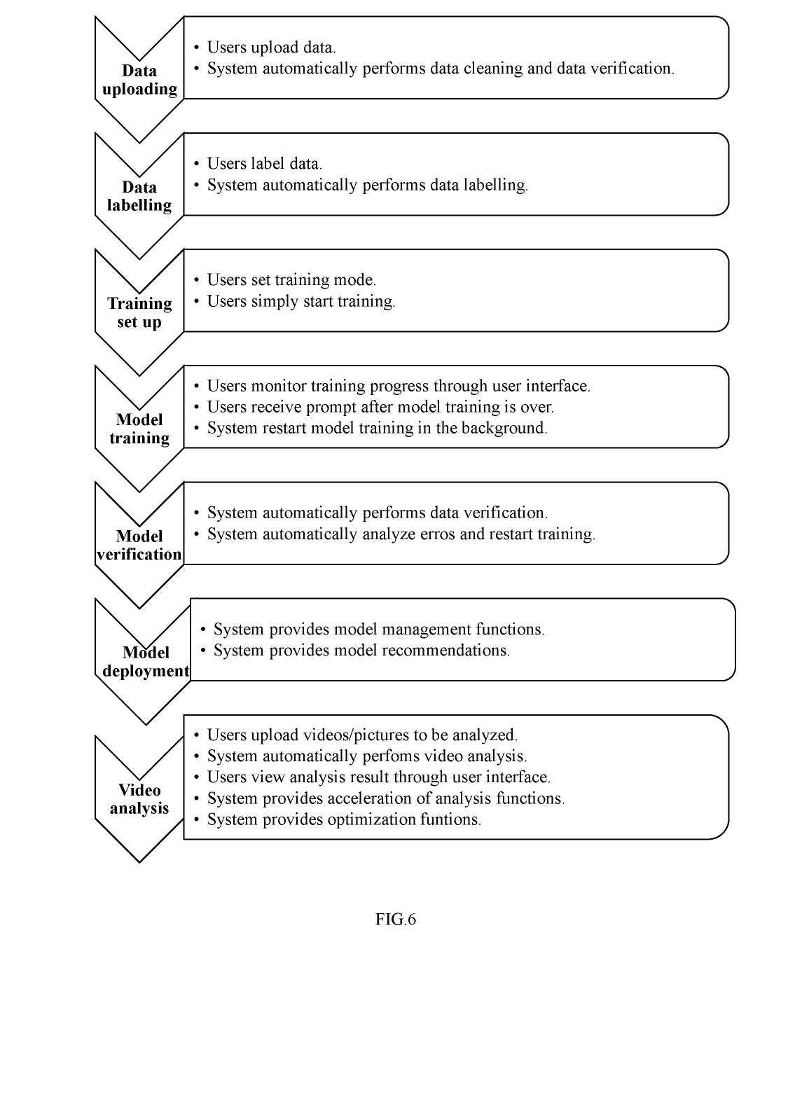

The present invention also teaches a method of providing customized self-training machine learning models for video analytics for rare targets. The method comprises the steps of processing data; automatically self-training a machine learning model using the processed data; wherein using meta-learning in the automatic model training for detecting rare targets; and analyzing a video based on the trained rare targets. FIG. 6 shows the sequence of steps involved in the user’s operations when operating the system 10 in the present invention.

In accordance with a preferred embodiment of the present invention, the processing data further comprises the step of uploading data; verifying and cleaning the uploaded data; enhancing the data; and labelling the data. The users only need to upload a small amount of private data to complete the customized model and apply it to video analysis. The system 10 automatically performs data cleaning and data verification. The specific goal of the video analysis in the present invention is determined by the data uploaded by the user, and the system developer or any other unrelated personnel do not have the right to access the training data, which is extremely confidential.

Further, the users also need to label the data. There are two ways of labelling the data, which are manual labelling or online team labelling whereby users can choose online team labelling to speed up the labelling process. The system 10 enables the smart labelling process once the labeled data reaches a certain amount. The users then may check or fine-tune the smart labeling results.

In accordance with a preferred embodiment of the present invention, the step of self-training machine learning model comprises displaying progress of current training, remaining time, and accuracy of current training; auto-tuning of hyperparameters; distributing training; and automatically starting or stopping the training. The users only need to simply set the training mode and start the training. The users can intuitively see the training progress, the current model accuracy, or other features on the user interface. After the model training is completed, the user receives a prompt.

In accordance with a preferred embodiment of the present invention, the step of self-training machine learning model further comprises detecting common targets and customized targets.

In accordance with a preferred embodiment of the present invention, the method further comprises providing preset scenarios and their mature models for video analysis models; and adopting the detection of common targets when the user’s needs are not met during the self-training of the machine learning model.

In accordance with a preferred embodiment of the present invention, the method further comprises using transfer learning; and freezing a pre-determined number of network layers for detecting customized targets with a large amount of training data. For some custom targets with a large amount of training data, the invention uses transfer learning and freeze some network layers to quickly achieve high accuracy.

In accordance with a preferred embodiment of the present invention, the method further comprises verifying the trained model to optimize the machine learning model after the training is completed. The system 10 automatically turns on the smart verification process. After the verification process is over, it automatically analyzes the errors and restarts the training in the background.

In accordance with a preferred embodiment of the present invention, the method further comprises performing data management, model management and labeling management using a user operation interface; and performing training task management using the user operation interface after verifying the trained model.

In accordance with a preferred embodiment of the present invention, the step of the analyzing of video comprises providing model recommendations 1531 and automatic deployment 1532; providing at least one image analysis 1621, video analysis 1622 and batch analysis 1623; accelerating the machine learning model; and activating optimization module 164 to realize automatic error analysis 141 and model automatic optimization 143 of the machine learning model to optimize video analysis performance. The automatic deployment 1532 further comprises of allowing user to manage, delete, find, and deploys models. The users then can choose whether to automatically deploy the recommendation model type.

To start the video analysis process, the users need to upload videos or pictures to be analyzed. The system 10 starts automatic video analysis, and the user can view the analysis results through the user interface.

In accordance with a preferred embodiment of the present invention, the method further comprises simultaneously updating output feedback to the machine learning models.

The present invention explained above is not limited to the aforementioned embodiment and drawings, and it will be obvious to those having an ordinary skill in the art of the prevent invention that various replacements, deformations, and changes may be made without departing from the scope of the invention.

1. A customized self-training machine learning system for video analytics for rare targets, comprising:
a data processing module;
a data annotation module with a labelling module;
an automatic model training module configured to self-train a machine learning model based on the user’s desire to detect rare targets;
a model verification module;
wherein the model verification module comprises an automatic error analysis and a label approval to optimize the machine learning model;
a model deployment module coupled with a user operation interface module; and
a video analysis module based on the trained rare targets.

2. The customized self-training machine learning system for video analytics for rare targets, according to claim 1, wherein the data processing module comprises an automatic data cleaning module, a data verification module, and a data enhancement module.

3. The customized self-training machine learning system for video analytics for rare targets, according to claim 1, wherein the automatic model training module comprises a unimodal, a cross-modal, and a multimodal.

4. The customized self-training machine learning system for video analytics for rare targets, according to claim 1, wherein the automatic model training module comprises at least one built-in algorithm.

5. The customized self-training machine learning system for video analytics for rare targets, according to claim 1, wherein the automatic model training module comprises meta-learning for detecting rare targets.

6. The customized self-training machine learning system for video analytics for rare targets, according to claim 1, wherein the automatic model training module comprises a visualization module, an auto-tuning of hyperparameters module, a distributed training module and an automatic start or stop module.

7. The customized self-training machine learning system for video analytics for rare targets, according to claim 1, wherein the rare targets comprise scarce, non-general and confidential objects such as medical or military imaging.

8. The customized self-training machine learning system for video analytics for rare targets, according to claim 1, wherein the automatic model training module is configured to detect common targets and customized targets.

9. The customized self-training machine learning system for video analytics for rare targets, according to claim 1, wherein the model deployment module comprises a data management module, a model packaging, a model management module, a labelling task management module, and a training task management module.

10. The customized self-training machine learning system for video analytics for rare targets, according to claim 9, wherein the model management module is configured to provide model recommendations for users viewing specific information based on the generated model information.

11. The customized self-training machine learning system for video analytics for rare targets, according to claim 1, wherein the video analysis module comprises a model management module, an analyzing module, an acceleration module, and an optimization module.

12. The customized self-training machine learning system for video analytics for rare targets, according to claim 11, wherein the optimization module is configured to execute automatic error analysis and model automatic optimization of the model to optimize the video analysis performance.

13. The customized self-training machine learning system for video analytics for rare targets, according to claim 1, wherein the system further comprises network-attached storage (NAS) or storage area network (SAN) providing secure and large-capacity data storage.

14. A method of providing customized self-training machine learning models for video analytics for rare targets, comprising of:
processing data;
automatically self-training a machine learning model using the processed data;
wherein using meta-learning in the automatic model training for detecting rare targets; and
analyzing a video based on the trained rare targets.

15. The method of providing customized self-training of machine learning models for video analytics for rare targets, according to claim 14, wherein the processing data comprises:
uploading data;
verifying and cleaning the uploaded data;
enhancing the data; and
labelling the data.

16. The method of providing customized self-training of machine learning models for video analytics for rare targets, according to claim 14, wherein the step of self-training machine learning model comprises:
displaying progress of current training, remaining time, and accuracy of current training;
auto-tuning of hyperparameters;
distributing training; and
automatically starting or stopping the training.

17. The method of providing customized self-training of machine learning models for video analytics for rare targets, according to claim 16, wherein the step of self-training machine learning model further comprises:
detecting common targets and customized targets.

18. The method of providing customized self-training of machine learning models for video analytics for rare targets, according to claim 17, wherein the method further comprises:
providing preset scenarios and their mature models for video analysis models; and
adopting the detection of common targets when the user’s needs are not met during the self-training of the machine learning model.

19. The method of providing customized self-training of machine learning models for video analytics for rare targets, according to claim 17, wherein the method further comprises:
using transfer learning; and
freezing a pre-determined number of network layers for detecting customized targets with a large amount of training data.

20. The method of providing customized self-training of machine learning models for video analytics for rare targets, according to claim 14, wherein the method further comprises verifying the trained model to optimize the machine learning model after the training is completed.

21. The method of providing customized self-training of machine learning models for video analytics for rare targets, according to claim 20, wherein the method further comprises:
performing data management, model management and labeling management using a user operation interface; and
performing training task management using the user operation interface after verifying the trained model.

22. The method of providing customized self-training of machine learning models for video analytics for rare targets, according to claim 14, wherein the analyzing of video comprises:
providing model recommendations and automatic deployment;
providing at least one image analysis, video analysis and batch analysis;
accelerating the machine learning model; and
activating optimization module to realize automatic error analysis and model automatic optimization of the machine learning model to optimize video analysis performance.

23. The method of providing customized self-training of machine learning models for video analytics for rare targets, according to claim 22, wherein the method further comprises simultaneously updating output feedback to the machine learning models.
